(19) United States
(12) Patent Application Publication
(10) Pub. No.: US 2026/0121119 A1
(43) Pub. Date: Apr. 30, 2026

(54) BATTERY

(71) Applicant: GUANGZHOU TINCI MATERIALS TECHNOLOGY CO., LTD., Guangzhou (CN)

(72) Inventors: Tianxiao Zhang, Guangzhou (CN); Xiaoyi Song, Guangzhou (CN); Tian Xie, Guangzhou (CN)

(73) Assignee: GUANGZHOU TINCI MATERIALS TECHNOLOGY CO., LTD., Guangzhou (CN)

(21) Appl. No.: 19/431,729

(22) Filed: Dec. 23, 2025

Related U.S. Application Data
(63) Continuation of application No. PCT/CN2024/135343, filed on Nov. 28, 2024.

(30) Foreign Application Priority Data
Sep. 13, 2024 (CN) 202411283546.2

(51) Int. Cl. H01M 10/0567; H01M 4/02; H01M 4/505; H01M 4/525

(52) U.S. Cl. CPC H01M 10/0567; H01M 4/505; H01M 4/525; H01M 2004/021; H01M 2004/027; H01M 2004/028

(57) ABSTRACT

The present disclosure provides a battery. The battery includes a positive electrode plate, a negative electrode plate, a separator, and an electrolyte. The negative electrode plate has a porosity of φ in unit of %. The separator has a thickness of t in unit of μm, and a pore size of R in unit of μm. A ratio of a total mass of the electrolyte to a discharge capacity of the battery is N in unit of g/Ah. The electrolyte includes an electrolyte additive. The electrolyte additive includes a sulfate ester compound and a first lithium salt additive. The first lithium salt additive includes an oxalate-containing lithium salt. The sulfate ester compound has a structure represented by Formula I. A mass fraction of the sulfate ester compound in the electrolyte is C in unit of %. The battery satisfies Formula A:

$$0.01 \leq \frac{φ \times N \times C}{1 {0}^{4} \times t \times R} \leq 0.5 . \qquad Formula A$$

### CROSS-REFERENCE TO RELATED APPLICATIONS

This application is a continuation-in-part of International Application No. PCT/CN2024/135343, filed on Nov. 28, 2024, which claims priority to the Chinese Patent Application No. 202411283546.2, titled “BATTERY”, and filed with China National Intellectual Property Administration on Sep. 13, 2024, the entire disclosure of which is incorporated herein by reference.

### FIELD

The present disclosure relates to the technical field of batteries, and particularly, to a battery.

### BACKGROUND

With the development of the renewable energy industry, higher energy density in power batteries has become a research and development focus in the industry. The use of a negative electrode active material with high energy density and a positive electrode active material with high specific energy can effectively increase the energy density of a lithium-ion battery. However, current high-energy-density batteries tend to exhibit adverse effects such as gas generation and breakage of the solid electrolyte interface (SEI) film under high-temperature conditions, resulting in poor high-temperature performance of the batteries. Therefore, there is an urgent need to develop a battery having improved high-temperature performance.

### SUMMARY

In a first aspect of the present disclosure, the present disclosure provides a battery. The battery includes a positive electrode plate, a negative electrode plate, a separator, and an electrolyte. The negative electrode plate has a porosity of φ in unit of %. The separator has a thickness of t in unit of μm, and a pore size of R in unit of μm. A ratio of a total mass of the electrolyte to a discharge capacity of the battery is N in unit of g/Ah. The electrolyte includes an electrolyte additive. The electrolyte additive includes a sulfate ester compound and a first lithium salt additive. The first lithium salt additive includes an oxalate-containing lithium salt. The sulfate ester compound has a structure represented by Formula I:

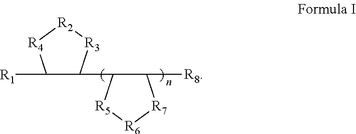

R₁ and R₈ are each independently selected from hydrogen or C₁ to C₅ hydrocarbyl; R₂, R₃, R₄, R₅, R₆, and R₇ are each independently selected from C₁ to C₃ alkylene, C₁ to C₃ alkoxy, an oxygen atom,

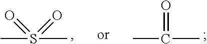

and n is an integer ranging from 0 to 4. A mass fraction of the sulfate ester compound in the electrolyte is C in unit of %. The battery satisfies Formula A:

$$0.01 \leq \frac{φ \times N \times C}{1 {0}^{4} \times t \times R} \leq 0.5 . \qquad Formula A$$

Thus, the battery can effectively alleviate problems such as gas generation and breakage/reconstruction of the SEI film in high-energy density batteries, thereby improving the high-temperature performance of the battery.

In some embodiments, φ ranges from 60% to 80%; and/or t ranges from 12 μm to 20 μm; and/or R ranges from 0.03 μm to 0.12 μm; and/or C ranges from 0.1% to 10%; and/or N ranges from 2.0 to 5.0. Thus, the high-temperature performance of the battery can be further improved.

In some embodiments, R₁ and R₈ are each independently selected from hydrogen;
at least one of R₂, R₃, or R₄ is selected from

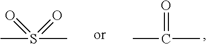

and at least one of R₂, R₃, or R₄ is selected from an oxygen atom;
at least one of R₅, R₆, or R₇ is selected from

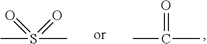

and at least one of R₅, R₆, or R₇ is selected from an oxygen atom;
n is 2.

In some embodiments, the sulfate ester compound has any one of the following structures:

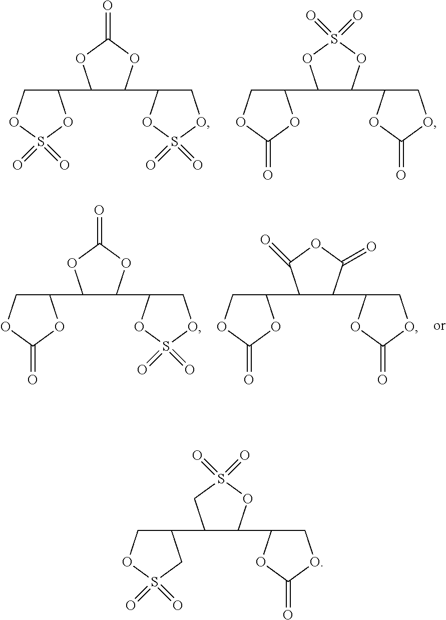

In some embodiments, the first lithium salt additive includes at least one of lithium difluoro(oxalato)borate, lithium bis(oxalato)borate, lithium tetrafluoro (oxalato)phosphate, lithium difluorobis(oxalato)phosphate, or lithium tris(oxalato)phosphate. Thus, the high-temperature performance, conductive performance, and cycling performance of the battery can be improved.

In some embodiments, a molar ratio of the first lithium salt additive to the sulfate ester compound is 1:(1 to 5). Thus, the inhibitory effect of the sulfate ester compound on the first lithium salt additive can be further enhanced. As a result, the hindered first lithium salt additive is less likely to move freely.

In some embodiments, a mass fraction of the first lithium salt additive in the electrolyte ranges from 0.1% to 5%; and/or a mass fraction of the sulfate ester compound in the electrolyte ranges from 1% to 10%. Thus, the stability of the battery under high-temperature and long-cycle conditions can be improved.

In some embodiments, the electrolyte additive further includes an electrolyte lithium salt. The electrolyte lithium salt includes at least one of LiBF₄, LiPF₆, LiAsF₆, or LiN(SO₂F)₂. Thus, the electrolyte lithium salt can further inhibit the corrosion of the SEI film and the cathode electrolyte interphase (CEI) film by hydrofluoric acid.

In some embodiments, a mass ratio of the electrolyte lithium salt to the first lithium salt additive is 1:(0.4 to 2).

In some embodiments, a mass fraction of the electrolyte lithium salt in the electrolyte ranges from 0.1% to 1%. Thus, the stability of the battery under the high-temperature and long-cycle conditions can be further improved.

In some embodiments, the positive electrode plate includes a positive electrode current collector and a positive electrode active material layer located on at least one side of the positive electrode current collector. The positive electrode active material layer includes a positive electrode active material. The positive electrode active material includes at least one of lithium iron phosphate, or a ternary material. The ternary material satisfies a chemical formula of LiNiₓCo_{y}M1_{z1}M2_{z2}O₂. M1 and M2 are different and each independently selected from one of Al, Mn, or Fe; and 0<x≤1, 0<y<1, 0<z1<1, 0≤z2<1, and x+y+z1+z2=1.

In some embodiments, the negative electrode plate includes a negative electrode current collector and a negative electrode active material layer located on at least one side of the negative electrode current collector. The negative electrode active material layer includes a negative electrode active material, and a mass fraction of silicon in the negative electrode active material is greater than 8%.

### DETAILED DESCRIPTION OF THE EMBODIMENTS

The embodiments described below are illustrative only, and are intended to explain rather than limit the present disclosure.

Unless otherwise defined, all technical and scientific terms used herein have the same meaning as commonly understood by those skilled in the art of the present disclosure. The terms in the present disclosure are only used for the purpose of describing exemplary embodiments, and are not intended to limit the present disclosure. Unless otherwise specified, numerical values of various parameters mentioned in the present disclosure can be measured using various measurement methods commonly used in the art (for example, they can be tested according to methods given in the embodiments of the present disclosure).

The terms such as “comprising”, “including” and “having” and any variations thereof as used in the specification and claims of the present disclosure are open-ended expressions, i.e., including contents specified in the present disclosure but not excluding other contents.

In a first aspect of the present disclosure, the present disclosure provides a battery. The battery includes a positive electrode plate, a negative electrode plate, a separator, and an electrolyte. The negative electrode plate has a porosity of φ in unit of %. The separator has a thickness of t in unit of μm, and a pore size of R in unit of μm. A ratio of a total mass of the electrolyte to a discharge capacity of the battery is N in unit of g/Ah. The electrolyte includes an electrolyte additive. The electrolyte additive includes a sulfate ester compound and a first lithium salt additive. The first lithium salt additive includes an oxalate-containing lithium salt. The sulfate ester compound has a structure represented by Formula

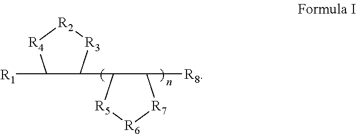

R₁ and R₈ are each independently selected from hydrogen or C₁ to C₅ hydrocarbyl; R₂, R₃, R₄, R₅, R₆, and R₇ are each independently selected from C₁ to C₃ alkylene, C₁ to C₃ alkoxy, an oxygen atom,

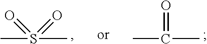

and n is an integer ranging from 0 to 4. A mass fraction of the sulfate ester compound in the electrolyte is C in unit of %. The battery satisfies Formula A:

$$0.01 \leq \frac{φ \times N \times C}{1 {0}^{4} \times t \times R} \leq 0.5 . \qquad Formula A$$

Thus, the battery can effectively alleviate problems such as gas generation or breakage/reconstruction of the SEI film in high-energy density batteries, thereby improving the high-temperature performance of the battery.

In the present disclosure, the sulfate ester compound has a pincer-shaped structure, and the pincer-shaped structure is surrounded by multiple double-bonded oxygen (such as carbonyl groups or sulfur-oxygen double bonds) atoms and single-bonded oxygen atoms. The oxalate-containing lithium salt has an “X”-shaped structure, and its molecular structure also has multiple carbonyl groups. When these two polar molecules are mixed, based on the spatial stereostructures of the two polar molecules, bulky structures of the carbonyl groups and the in sulfur-oxygen double bonds can insert into the structural gap of the oxalate-containing lithium salt, thereby restricting the free movement of the oxalate-containing lithium salt to a certain extent. On the other hand, the two polar molecules, when mixed, undergo mutual repulsion due to the large number of the carbonyl groups and/or the sulfur-oxygen double bonds in their structures. Such a mutually repulsive orientational force causes the oxalate-containing lithium salt molecules and the sulfate ester compound molecules to rotate relative to each other to balance this repulsion. That is, the planar configurations of the two substances tend to transition into an intersecting state from a quasi-parallel state, which is conducive to the large bulky structures of the carbonyl groups and the sulfur-oxygen double bonds in the sulfate ester compound tending to insert into the structural gaps of the oxalate-containing lithium salt molecules, thereby leading to inhibition of steric hindrance on the oxalate-containing lithium salt. The repulsion between the two polar molecules is conducive to the restriction of the free movement of the oxalate-containing lithium salt molecules by the pincer-shaped structure of the sulfate ester. Further, the hindered oxalate-containing lithium salt is less likely to move freely under the dual effects of the intermolecular repulsion and spatial confinement.

When the electrolyte additive is used in a battery, the reduced free movement of the hindered oxalate-containing lithium salt can decrease the direct contact between the oxalate group and the electrode plate, making it less likely for a gas-generation reaction of the oxalate group to occur. Meanwhile, the damage to the SEI film caused by battery swelling due to gas generation is reduced. Thus, the stability of the battery under high-temperature and long-cycle conditions is improved.

Further, φ×C×N in Formula A can collectively indicate the total influence of favorable factors. Specifically, when the porosity φ of the negative electrode plate is large, the transmission rate of lithium ions can be increased, thereby improving fast-charging cycling performance. When the mass fraction C of the sulfate ester compound in the electrolyte is higher within a specific range, the performance improvement effect is better. The ratio N of the total mass of the electrolyte to the discharge capacity of the battery reflects that the sulfate ester compound has a strong discharge capacity. t×R in Formula A can collectively indicate the total influence of unfavorable factors. Specifically, when the thickness t of the separator is too thick, or when the pore size R of the separator is too large, the internal impedance of the battery increases, and large molecular impurities pass through the separator and induce side reactions at the electrode plate, thereby deteriorating the performance of the battery. Accordingly, when

$$\frac{φ \times N \times C}{{10}^{4} \times t \times R}$$

is too small, the internal impedance of the battery is too high and adverse side reactions are aggravated. When

$$\frac{φ \times N \times C}{{10}^{4} \times t \times R}$$

is too large, the output voltage of the battery is unstable and toxic gases may be generated.

Still further, when the sulfate ester compound is used in combination with the first lithium salt additive, the aforementioned battery is applicable to a battery system using a medium-nickel positive electrode and a silicon-based negative electrode, and can exert advantageous effects in this battery system.

It should be noted that in the electrolyte additive of the present disclosure: the orientational force generated by the mutual repulsion between the polar molecules and the spatial restriction effect do not completely prevent the oxalate-containing lithium salt from exerting its advantages. Instead, they effectively slow down the movement of the oxalate-containing lithium salt, making the gas-generation reaction less likely to occur, thereby reducing damage to the SEI film and further promoting the performance stability of the battery under the high-temperature and long-cycle conditions.

The term “C₁ hydrocarbyl to C₅ hydrocarbyl” refers to a saturated straight-chain or branched hydrocarbon moiety containing 1 carbon atom to 5 carbon atoms, such as CH₃— or C₂H₅—.

The term “C₁ alkylene to C₃ alkylene” refers to a straight-chain saturated hydrocarbyl containing 1 carbon atom to 3 carbon atoms, such as methylene or ethylene.

The term C₁ alkoxy to C₃ alkoxy refers to a —OR moiety, where R is a C₁ alkyl to C₃ alkyl, such as ethoxy or n-propoxy.

As an example, n is an integer ranging from 0 to 4, such as 0, 1, 2, 3, or 4.

The sulfate ester compound has a pincer-shaped structure, and the pincer-shaped structure is surrounded by multiple double-bonded oxygen (such as carbonyl groups or sulfur-oxygen double bonds) atoms and single-bonded oxygen atoms.

When the first lithium salt additive is used in the battery electrolyte, it helps to improve the high-temperature performance, conductive performance, and cycling performance of the battery, for the oxalate group in the first lithium salt additive has high electronegativity toward fluorine and can also form covalent bonds with carbon elements, thereby increasing the boiling point of the electrolyte. Meanwhile, it can cause compounds in the electrolyte to form small solvent clusters, thereby promoting fluidity and conductive performance of the electrolyte.

In some embodiments, φ ranges from 60% to 80%; and/or t ranges from 12 μm to 20 μm; and/or R ranges from 0.03 μm to 0.12 μm; and/or C ranges from 0.1% to 10%; and/or N ranges from 2.0 to 5.0. Thus, the high-temperature performance of the battery can be further improved.

When the porosity φ of the negative electrode plate falls within the aforementioned range, it can provide more space to accommodate expansion. It effectively alleviates volume expansion of the negative electrode active material, such as a silicon-based material, and effectively maintaining the integrity of the SEI film of the negative electrode.

When the thickness t of the separator falls within the aforementioned range, it can not only hinder the movement of the oxalate-containing lithium salt but also exert less adverse effects on the transmission rate of the lithium ions.

When the ratio N of the total mass of the electrolyte to the discharge capacity of the battery falls within the aforementioned range, the discharge capacity of the battery is better. When the pore size R of the separator falls within the aforementioned range, the migration capability of the lithium ions in the electrolyte is better.

In some embodiments, R₁ and R₈ are each independently selected from hydrogen;
at least one of R₂, R₃, or R₄ is selected from

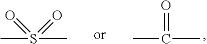

and at least one of R₂, R₃, or R₄ is selected from an oxygen atom;
at least one of R₅, R₆, or R₇ is selected from

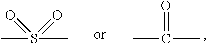

and at least one of R₅, R₆, or R₇ is selected from an oxygen atom;
n is 2.

In some embodiments, the sulfate ester compound has any one of the following structures:

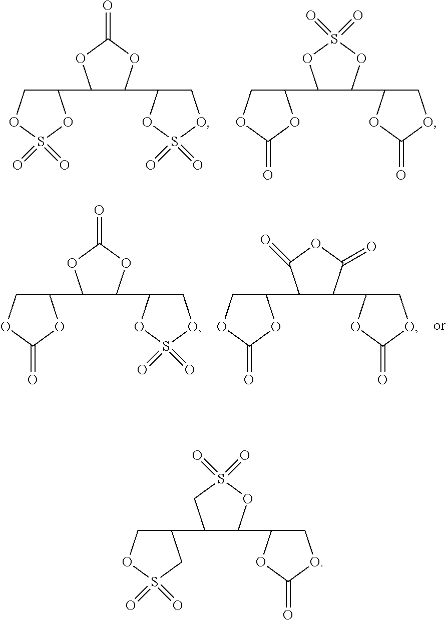

In some embodiments, the first lithium salt additive includes at least one of lithium difluoro(oxalato)borate, lithium bis(oxalato)borate, lithium tetrafluoro(oxalato)phosphate, lithium difluorobis(oxalato)phosphate, or lithium tris(oxalato)phosphate. Thus, it is beneficial for improving the high-temperature performance, the conductive performance, and the cycling performance.

As an example, the first lithium salt additive is lithium difluoro(oxalato)borate. Lithium difluoro(oxalato)borate is beneficial for improving the conductive performance and optimizing high and low temperature performance and thermal stability.

In some embodiments, a molar ratio of the first lithium salt additive to the sulfate ester compound is 1:(1 to 5). Thus, the inhibitory effect of the sulfate ester compound on the first lithium salt additive can be further enhanced. As a result, the hindered first lithium salt additive is less likely to move freely.

In some embodiments, the molar ratio of the first lithium salt additive to the sulfate ester compound is 1:(1 to 5), such as 1:1, 1:1.6, 1:2, 1:3, 1:3.4, 1:4, or 1:5.

In some embodiments, the molar ratio of the first lithium salt additive to the sulfate ester compound is 1:(2 to 4). Therefore, the sulfate ester compound is in a slightly excessive state relative to the first lithium salt additive, which can further enhance the inhibitory effect of the sulfate ester compound on the first lithium salt additive, thereby making it difficult for the hindered first lithium salt additive to move freely.

In some embodiments, a mass fraction of the first lithium salt additive in the electrolyte ranges from 0.1% to 5%.

As an example, the mass fraction of the first lithium salt additive in the electrolyte is 0.1%, 0.5%, 1%, 1.5%, 2%, 3%, 4%, 5%, etc. Thus, the stability of the battery under the high-temperature and long-cycle conditions can be further improved.

In some embodiments, a mass fraction C of the sulfate ester compound in the electrolyte ranges from 1% to 10%.

As an example, the mass fraction of the sulfate ester compound in the electrolyte is 1%, 1.07%, 1.4%, 1.7%, 2%, 3%, 3.4%, 4%, 5%, 6%, 6.9%, 7%, 8%, 8.7%, 9%, 10%, etc. Thus, the stability of the battery under the high-temperature and long-cycle conditions can be further improved.

There is fluorine in the electrolyte. As the battery reaction proceeds, the fluorine generates hydrogen fluoride, corroding the SEI film and the CEI film. It leads to problems of the battery such as reduction of high-temperature storage capacity, gas generation and swelling.

In some embodiments, the electrolyte additive further includes an electrolyte lithium salt. The electrolyte lithium salt includes at least one of LiBF₄, LiPF₆, LiAsF₆, or LiN(SO₂F)₂. As a result, the electrolyte lithium salt can further inhibit the corrosion of the SEI film and the CEI film by hydrofluoric acid. Thus, the first lithium salt additive, the sulfate ester compound, and the electrolyte lithium salt interact with each other, making it difficult for the hindered oxalate-containing lithium salt to move freely. Moreover, the first lithium salt additive can also inhibit hydrolysis of the oxalate-containing lithium salt. At the same time, for the fluorine-containing lithium salt therein, the generation of fluoride ions can be reduced, leading to reduced generation of hydrofluoric acid, thereby reducing the corrosion of the SEI film and the CEI film by hydrofluoric acid. In this way, the high-temperature storage capacity of the battery is increased, and gas generation and swelling of the battery are effectively reduced.

Further, the electrolyte lithium salt is LiBF₄. LiBF₄ is more stable at high temperatures, which is beneficial for further inhibiting the generation of hydrogen fluoride and thus improving the high-temperature performance of the battery.

In some embodiments, a mass ratio of the electrolyte lithium salt to the first lithium salt additive is 1:(0.4 to 2).

In some embodiments, the mass ratio of the electrolyte lithium salt to the first lithium salt additive is 1:(0.4-2), such as 1:0.4, 1:0.5, 1:1, 1:1.5, 1:1.75, or 1:2.

In some embodiments, a mass fraction of the electrolyte lithium salt in the electrolyte ranges from 0.1% to 1%. Thus, the stability of the battery under the high-temperature and long-cycle conditions can be further improved.

As an example, the mass fraction of the electrolyte lithium salt in the electrolyte is 0.1%, 0.15%, 0.3%, 0.5%, 0.8%, 1%, etc. Thus, the stability of the battery under the high-temperature and long-cycle conditions can be further improved.

In the present disclosure, the electrolyte may optionally further include a second additive. The second additive may be selected based on specific applications of the electrolyte in different batteries.

In some embodiments, the second additive includes at least one of ethylene sulfate (DTD), vinylene carbonate, fluoroethylene carbonate (FEC), vinyl ethylene carbonate, ethylene sulfate, 1,3-propanesultone, 1,3-propylenesultone, ethylene sulfite, tris(trimethylsilyl)borate, or tris(trimethylsilyl)phosphate. Thus, the electrolyte is particularly suitable for use in silicon negative electrode batteries to further improve the cycling performance and the high-temperature storage performance of the battery.

In some embodiments, a mass fraction of the second additive in the electrolyte ranges from 0.5% to 20%, such as 0.5%, 1%, 1.5%, 2%, 3%, 4%, 5%, 6%, 7%, 8%, 9%, 10%, 15%, or 20%.

In the present disclosure, the electrolyte may be a non-aqueous electrolyte, and a solvent of the non-aqueous electrolyte is an organic solvent.

In some embodiments, the organic solvent includes at least one of ethylene carbonate (EC), propylene carbonate (PC), butylene carbonate, dimethyl carbonate, diethyl carbonate (DEC), ethyl methyl carbonate (EMC), methyl propyl carbonate, methyl acetate, ethyl acetate, propyl acetate, methyl propionate, ethyl propionate, propyl propionate, methyl butyrate, ethyl butyrate, γ-butyrolactone, γ-valerolactone, δ-valerolactone, or ε-caprolactone.

In some embodiments, a mass fraction of the organic solvent in the electrolyte ranges from 10% to 80%.

In some embodiments, the organic solvent includes EC, PC, EMC, and DEC. EC has a high dielectric constant, which can ensure full dissolution and ionization of the lithium salts. In this way, the conductivity of the electrolyte is effectively improved to ensure a cycle life. EMC and DEC are linear carbonates, which have advantages of low viscosity and a low melting point compared with cyclic carbonates (EC). Therefore, a mixture of PC, EMC, DEC, and EC is used as the electrolyte solvent to improve the performance of the battery.

In some embodiments, a mass ratio of the organic solvent to the sulfate ester compound in the electrolyte is (8 to 170): 1, such as 8:1, 15:1, 30:1, 40:1, 75:1, 95:1, 120:1, 140:1, or 170:1. Thus, the stability of the battery under the high-temperature and long-cycle conditions can be further improved.

In the present disclosure, the electrolyte may further include a third lithium salt. The third lithium salt further includes at least one of lithium perchlorate, lithium bis(fluorosulfonyl)imide, lithium difluorophosphate, or lithium hexafluoroarsenate.

In some embodiments, the mass fraction of the third lithium salt in the electrolyte ranges from 10% to 20%, such as 10%, 13%, 15%, 18%, or 20%.

Generally, in addition to the electrolyte, the battery further includes a positive electrode plate, a negative electrode plate, and a separator. During the charge and discharge process of the battery, active ions are intercalated and deintercalated back and forth between the positive electrode plate and the negative electrode plate. The electrolyte functions for ion conduction between the positive electrode and the negative electrode. The separator is disposed between the positive electrode plate and the negative electrode plate, mainly preventing a short circuit between a positive electrode and a negative electrode, while allowing ions to pass through.

In some embodiments, the positive electrode plate includes a positive electrode current collector and a positive electrode active material layer located on at least one side of the positive electrode current collector. The positive electrode active material layer includes a positive electrode active material. The positive electrode active material includes at least one of lithium iron phosphate, or a ternary material. The ternary material satisfies a chemical formula of LiNiₓCo_{y}M1_{z1}M2_{z2}O₂, where M1 and M2 are different and each independently selected from one of Al, Mn, or Fe; and 0<x≤1, 0<y<1, 0<z1<1, 0≤z2<1, and x+y+z1+z2=1.

In some embodiments, when the ternary material is a cobalt-containing positive electrode active material, under the dual effects of the spatial restriction and intermolecular repulsion between the sulfate ester compound and the first lithium salt additive, the concentration of the oxalate near the electrode is significantly diminished. As a result, the probability of oxalate reacting with dissolved Co ions to form cobalt oxalate precipitates is greatly reduced, which in turn reduces damage to the electrode plate caused by the precipitates and decreases the impedance of the battery. The sulfate ester compound can undergo a complexation reaction with the dissolved Co ions, reducing occurrence of side reactions of the dissolved Co ions in the battery system, thereby improving the stability of the battery under the high-temperature and long-cycle conditions. Further, part of the sulfate ester compound may decompose at the negative electrode of the battery to form the SEI film, which can limit the deintercalation of the Co ions. Therefore, the electrolyte including the electrolyte additive according to the first aspect of the present disclosure or the electrolyte according to the second aspect of the present disclosure is particularly suitable for use in combination with the cobalt-containing positive electrode active material in the battery system.

As an example, the positive electrode active material includes LiNi_{0.6}Co_{0.2}Mn_{0.2}O₂ (NCM622), LiNi_{0.6}Co_{0.1}Mn_{0.3}O₂ (NCM613), or LiNi_{0.5}Co_{0.2}Mn_{0.3}O₂ (NCM523), etc.

In some embodiments, the positive electrode active material includes lithium iron phosphate. Thus, the sulfate ester compound can also undergo a complexation reaction with dissolved metal ions (such as Fe ions), suppressing side reactions of the dissolved metal ions in the battery system, thereby improving the stability of the battery under the high-temperature and long-cycle conditions. Further, part of the sulfate ester compound may also decompose at the negative electrode of the battery to form the SEI film, which can limit the deintercalation of the metal ions.

In some embodiments, the positive electrode active material layer may further include a binder. Specific examples of the binder include, but are not limited to, one or more of polyvinylidene fluoride (PVDF), polytetrafluoroethylene (PTFE), vinylidene fluoride-tetrafluoroethylene-propylene terpolymer, or styrene-butadiene rubber (SBR).

In some embodiments, the positive electrode active material layer may further include a conductive agent. Specific examples of the conductive agent include, but are not limited to, superconducting carbon, acetylene black, carbon black, Ketjen black, carbon dots, carbon nanotubes, graphene, and the like.

In some embodiments, the positive electrode current collector may be a metallic foil, such as an aluminum foil.

In some embodiments, the negative electrode plate includes a negative electrode current collector and a negative electrode active material layer located on at least one side of the negative electrode current collector. The negative electrode active material layer includes a negative electrode active material, and a mass fraction of silicon in the negative electrode active material is greater than 8%. Increasing the specific capacity of the negative electrode active material can effectively improve the energy density of the battery. Currently, the specific capacity of graphite materials has reached its theoretical upper limit (372 mAh/g), while a highest theoretical specific capacity of silicon-based negative electrode active materials can reach 4200 mAh/g. The silicon-based negative electrode active materials have great application prospects. The volume of the silicon-based negative electrode active materials changes greatly during the charge and discharge process of the battery. During repeated charge and discharge cycles, the SEI film on a surface of a silicon-based negative electrode repeatedly breaks and forms due to the excessive changes in volume expansion and contraction of the silicon-based negative electrode itself, which continuously consumes the electrolyte, resulting in relatively poor cycling performance of the battery. In the present disclosure, the problems including corrosion and gas generation of the SEI film can be effectively improved by optimizing the composition of the electrolyte additive.

In some embodiments, the negative electrode active material layer may further include a binder. Specific examples of the binder include, but are not limited to, one or more of styrene-butadiene rubber (SBR), polyacrylic acid (PAA), polyacrylamide (PAM), or polyvinylidene fluoride (PVDF).

In some embodiments, the negative electrode active material layer may further include a conductive agent. Specific examples of the conductive agent include, but are not limited to, superconducting carbon, acetylene black, carbon black, graphene, and the like.

In some embodiments, the negative electrode active material layer may further include a thickener, such as sodium carboxymethyl cellulose (CMC-Na).

The present disclosure has no particular restrictions on the type of the separator, and various separators of a porous structure and having good stability can be selected, such as a polyethylene (PE) separator, a polypropylene separator, or a PE ceramic-coated separator.

The scheme of the present disclosure is described below through specific examples. It should be noted that the following examples are only used for illustrating the present disclosure and should not be construed as limiting the scope of the present disclosure.

In the following examples:

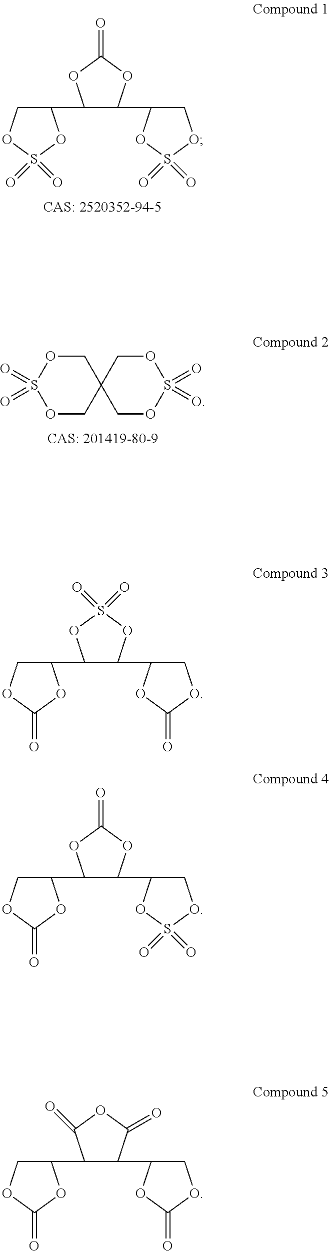 [SMILES: O=C1OC(C2COS(=O)(=O)O2)C(C2COS(=O)(=O)O2)O1 ; O=S1(=O)OCC2(CO1)COS(=O)(=O)OC2 ; O=C1OCC(C2OS(=O)(=O)OC2C2COC(=O)O2)O1 ; O=C1OCC(C2OC(=O)OC2C2COS(=O)(=O)O2)O1 ; O=C1OCC(C2C(=O)OC(=O)C2C2COC(=O)O2)O1]

The following examples are used for illustrating applications of the electrolyte additive and the electrolyte containing the same in a lithium-ion battery with NCM613 positive electrode of the present disclosure.

### Example 1a

### Preparation of Positive Electrode Plate:

A positive electrode active material NCM613, a binder polyvinylidene fluoride (PVDF), a conductive agent SP, and a conductive agent CNT were mixed at a weight ratio of 95:3:0.5:1.5, and N-methylpyrrolidone (NMP) was added to form a slurry, with a solid content controlled at 55%. The mixture was stirred in a vacuum mixer until a homogeneous and flowable positive electrode slurry was obtained. The positive electrode slurry was uniformly coated onto an aluminum foil having a thickness of 16 μm. The aluminum foil coated with the positive electrode slurry was dried in an oven at 120° C. for 8 hours. Finally, calendering is carried out to control the compacted density of the positive electrode plate at 3.5 g/cm³, followed by slitting, to obtain the positive electrode plate.

### Preparation of Negative Electrode Plate:

Graphite/Zichen silicon-carbon 550-M5-230415 as a negative electrode active material, a conductive agent SP, a binder SBR (JSR-104A), and a thickener CMC (crt30000PA) were mixed at a weight ratio of 95:1.5:2:1.5, and water was added to form a slurry, with a solid content controlled at 45%. The mixture was stirred in a vacuum mixer to obtain a negative electrode slurry. The negative electrode slurry was uniformly coated onto a copper foil having a thickness of 9 μm. The copper foil coated with the negative electrode slurry was dried at 85° C. for 5 hours. Finally, calendering is carried out to control the compacted density of the negative electrode plate at 1.6 g/cm³, followed by slitting, to obtain the negative electrode plate. The porosity q of the negative electrode plate was 70%.

### Preparation of Electrolyte:

In an argon-filled glove box (having a moisture content<10 ppm and an oxygen content<1 ppm), solvents EC, PC, DEC, and EMC were mixed uniformly at a mass percentage of 3:3:4:10 to obtain an organic solvent. The electrolyte additives (Compound 1 and a first lithium salt additive (lithium difluoro (oxalate) borate), an electrolyte lithium salt (LiBF₄), and a second additive (FEC and DTD) were added to the organic solvent and stirred uniformly, to obtain a non-aqueous electrolyte. The mass of the electrolyte was 9 g.

### Preparation of Separator:

A double-layer PP ceramic-coated separator was selected. The separator had a thickness t of 16 μm and a pore size R of 0.08 μm.

### Preparation of Lithium-Ion Battery:

The positive electrode plate, separator, and negative electrode plate prepared above were wound to obtain an unfilled bare cell. The bare cell was placed in an outer package, and the prepared electrolyte was injected into the dried bare cell. The cell was then subjected to vacuum sealing, standing, formation, shaping, and grading to obtain a lithium-ion battery. The discharge capacity of the battery was determined by first fully charging the battery, then discharging it at 0.5C (half of the capacity of the battery), and recording the discharge duration multiplied by the discharge current, as the discharge capacity.

The differences between Examples 2a to 19a and Comparative Examples 1a to 3a and Example 1a are shown in Table 1-1.

TABLE 1-1

| | | | | | | | Molar | Mass | Ratio of | |
|---|---|---|---|---|---|---|---|---|---|---|
| | | | | | | | ratio of | ratio of | total mass | |
| | | | | | | | first | electrolyte | of | |
| | | | | | | | lithium | lithium | electrolyte | |
| | | | First | | | | salt | salt to | to | |
| | Sulfate ester | | lithium salt | | Electrolyte | | additive | first | discharge | |
| | compound | | additive | | lithium salt | | to sulfate | lithium | capacity of | |
| No. | Type | Content, wt % | Type | Content, wt % | Type | Content, wt % | ester compound | salt additive | battery N/(g/Ah) | $\frac{φ \times N \times C}{1 {0}^{4} \times t \times R}$ |
| Example | Compound | 3.40 | Lithium | 0.3 | LiBF₄ | 0.15 | 0.1 | 0.5 | 4.95 | 0.09 |
| 1a | 1 | | difluoro | | | | | | | |
| | | | (oxalato) | | | | | | | |
| | | | borate | | | | | | | |
| Example | Compound | 1.39 | Lithium | 0.3 | LiBF₄ | 0.15 | 0.5 | 0.5 | 5.25 | 0.04 |
| 2a | 1 | | difluoro | | | | | | | |
| | | | (oxalato) | | | | | | | |
| | | | borate | | | | | | | |
| Example | Compound | 0.69 | Lithium | 3 | LiBF₄ | 0.15 | 1 | 0.05 | 7.33 | 0.03 |
| 3a | 1 | | difluoro | | | | | | | |
| | | | (oxalato) | | | | | | | |
| | | | borate | | | | | | | |
| Example | Compound | 23.23 | Lithium | 5 | LiBF₄ | 0.15 | 0.5 | 0.03 | 4.05 | 0.52 |
| 4a | 1 | | difluoro | | | | | | | |
| | | | (oxalato) | | | | | | | |
| | | | borate | | | | | | | |
| Example | Compound | 0.46 | Lithium | 0.1 | LiBF₄ | 0.15 | 0.5 | 1.5 | 8.42 | 0.02 |
| 5a | 1 | | difluoro | | | | | | | |
| | | | (oxalato) | | | | | | | |
| | | | borate | | | | | | | |
| Example | Compound | 1.39 | Lithium | 0.3 | LiBF₄ | 1 | 0.5 | 3.33 | 7.41 | 0.06 |
| 6a | 1 | | difluoro | | | | | | | |
| | | | (oxalato) | | | | | | | |
| | | | borate | | | | | | | |
| Example | Compound | 1.39 | Lithium | 0.3 | LiBF₄ | 0.1 | 0.5 | 0.33 | 8.62 | 0.07 |
| 7a | 1 | | difluoro | | | | | | | |
| | | | (oxalato) | | | | | | | |
| | | | borate | | | | | | | |
| Example | Compound | 1.39 | Lithium | 0.3 | LiBF₄ | 0.5 | 0.5 | 1.67 | 5.13 | 0.04 |
| 8a | 1 | | difluoro | | | | | | | |
| | | | (oxalato) | | | | | | | |
| | | | borate | | | | | | | |
| Example | Compound | 0.1 | Lithium | 0.02 | LiBF₄ | 0.15 | 0.5 | 7.5 | 12.36 | 0.01 |
| 9a | 1 | | difluoro | | | | | | | |
| | | | (oxalato) | | | | | | | |
| | | | borate | | | | | | | |
| Example | Compound | 5 | Lithium | 1.07 | LiBF₄ | 0.15 | 0.5 | 0.14 | 4.91 | 0.14 |
| 10a | 1 | | difluoro | | | | | | | |
| | | | (oxalato) | | | | | | | |
| | | | borate | | | | | | | |
| Example | Compound | 10 | Lithium | 2.15 | LiBF₄ | 0.15 | 0.5 | 0.07 | 4.14 | 0.23 |
| 11a | 1 | | difluoro | | | | | | | |
| | | | (oxalato) | | | | | | | |
| | | | borate | | | | | | | |
| Example | Compound | 1.39 | Lithium | 0.3 | LiBF₄ | 0.15 | 0.5 | 0.5 | 5.36 | 0.04 |
| 12a | 2 | | difluoro | | | | | | | |
| | | | (oxalato) | | | | | | | |
| | | | borate | | | | | | | |
| Example | Compound | 1.39 | Lithium | 0.3 | LiBF₄ | 0.15 | 0.5 | 0.5 | 5.41 | 0.04 |
| 13a | 3 | | difluoro | | | | | | | |
| | | | (oxalato) | | | | | | | |
| | | | borate | | | | | | | |
| Example | Compound | 1.39 | Lithium | 0.3 | LiBF₄ | 0.15 | 0.5 | 0.5 | 5.38 | 0.04 |
| 14a | 4 | | difluoro | | | | | | | |
| | | | (oxalato) | | | | | | | |
| | | | borate | | | | | | | |
| Example | Compound | 1.39 | Lithium | 0.3 | LiBF₄ | 0.15 | 0.5 | 0.5 | 5.47 | 0.04 |
| 15a | 5 | | difluoro | | | | | | | |
| | | | (oxalato) | | | | | | | |
| | | | borate | | | | | | | |
| Example | Compound | 1.39 | Lithium | 0.3 | LiBF₄ | 0.15 | 0.5 | 0.5 | 5.36 | 0.04 |
| 16a | 1 | | tetrafluoro | | | | | | | |
| | | | (oxalato) | | | | | | | |
| | | | phosphate | | | | | | | |
| Example | Compound | 1.39 | Lithium | 0.3 | LiPF₆ | 0.15 | 0.5 | 0.5 | 5.37 | 0.04 |
| 17a | 1 | | difluoro | | | | | | | |
| | | | (oxalato) | | | | | | | |
| | | | borate | | | | | | | |
| Example | Compound | 1.39 | Lithium | 0.3 | LiN | 0.15 | 0.5 | 0.5 | 5.44 | 0.04 |
| 18a | 1 | | difluoro | | (SO₂F)₂ | | | | | |
| | | | (oxalato) | | | | | | | |
| | | | borate | | | | | | | |
| Example | Compound | 1.39 | Lithium | 0.3 | / | / | 0.5 | / | 14.31 | 0.11 |
| 19a | 1 | | difluoro | | | | | | | |
| | | | (oxalato) | | | | | | | |
| | | | borate | | | | | | | |
| Comparative | Compound | 1.39 | / | / | LiBF₄ | 0.15 | / | / | 16.15 | 0.12 |
| Example | 1 | | | | | | | | | |
| 1a | | | | | | | | | | |
| Comparative | / | / | Lithium | 0.3 | LiBF₄ | 0.15 | / | 0.5 | 21.16 | / |
| Example | | | difluoro | | | | | | | |
| 2a | | | (oxalato) | | | | | | | |
| | | | borate | | | | | | | |
| Comparative | / | / | / | / | LiBF₄ | 0.15 | / | / | 23.26 | / |
| Example | | | | | | | | | | |
| 3a | | | | | | | | | | |

The differences between Examples 20a to 27a and Example 1a are shown in Table 1-2.

TABLE 1-2

| | | | | Ratio of total | |
|---|---|---|---|---|---|
| | | | | mass of | |
| | | | | electrolyte to | |
| | | | | battery | |
| | Porosity φ/% | Thickness | | discharge | |
| No. | of negative electrode plate | t/μm of separator | Pore size R/μm of separator | capacity N/(g/Ah) | $\frac{φ \times N \times C}{1 {0}^{4} \times t \times R}$ |
| Example la | 70 | 16 | 0.08 | 4.95 | 0.09 |
| Example 20a | 60 | 16 | 0.08 | 4.95 | 0.03 |
| Example 21a | 80 | 16 | 0.08 | 4.95 | 0.04 |
| Example 22a | 70 | 12 | 0.08 | 4.95 | 0.05 |
| Example 23a | 70 | 20 | 0.08 | 4.95 | 0.03 |
| Example 24a | 70 | 16 | 0.03 | 4.95 | 0.10 |
| Example 25a | 70 | 16 | 0.12 | 4.95 | 0.03 |
| Example 26a | 70 | 16 | 0.08 | 2 | 0.02 |
| Example 27a | 70 | 16 | 0.08 | 3.5 | 0.03 |

The following tests were performed on the aforementioned examples and comparative examples, and the test results are shown in Table 2.

### (1) High-Temperature Storage Performance Test:

The lithium-ion battery was placed in a constant temperature box at 60° C. and was left to stand for 6 hours. The battery was charged to an upper limit voltage of 4.4 V at a constant current and constant voltage of 1C, with a cut-off current of 0.05C. After the battery was fully charged, it was left to stand for 5 minutes, and then discharged to a cut-off voltage of 2.75V at a constant current of 1C. The gas generation volume of the fully charged battery (100% SOC) was measured by the water displacement method before storage. After storage for 60 days, the capacity retention rate and the gas generation volume were measured by the water displacement method.

$$Capacity Retention Rate ( \% ) = Remaining Capacity after Discharge / Initial Capacity \times 100 \% .$$

$$Gas Generation Volume by Water Displacement Method ( {m}^{3} ) = ( Initial Weight - Weight after Water Displacement ) / Density of Water .$$

### (2) High-Temperature Cycling Performance Test:

At 45° C., the lithium-ion battery was first charged to a voltage of 4.5 V at a constant current of 1C. At this time, the thickness of the lithium-ion battery was recorded as H₀. Then, the lithium-ion battery was discharged to 2.75 V at a constant current of 1C, and the initial capacity before storage was recorded as C₀. The lithium-ion battery was first charged to a voltage of 4.5 V at a constant current of 0.3C, and the initial capacity was recorded as Q₀. The capacity after 800 cycles was recorded as Q₁. The capacity retention rate after 500 cycles at 1 C was calculated by Formula (1):

$$Capacity Retention Rate after 500 Cycles at 45 ° C . ( \% ) = {Q}_{1} / {Q}_{0} \times 100 \%$$

### (3) Room-Temperature Cycling Performance Test:

The prepared lithium-ion battery was placed in a 25° C. environment, charged to a voltage of 4.5 V at a constant current of 1C, and then discharged to 2.75 V at a constant current of 1C. The initial capacity was recorded as Q₀, and the capacity after 800 cycles was recorded as Q₁. The capacity retention rate after 500 cycles at 1 C was calculated by Formula (1):

$$Capacity Retention Rate after 500 Cycles ( \% ) = {Q}_{1} / {Q}_{0} \times 100 \%$$

The relevant test results of the above examples and comparative examples are shown in Table 2.

TABLE 2

| | | Gas generation | | Gas generation | |
|---|---|---|---|---|---|
| | | volume by | | volume by | |
| | Capacity | water | | water | Capacity |
| | retention rate | displacement | Capacity | displacement | retention rate |
| | after 500 | method after | retention after | method after | after 500 |
| | cycles at | full charge at | 60-day storage | 60-day storage | cycles at room |
| No. | 45° C., % | 60° C., cm³ | at 60° C., % | at 60° C., cm³ | temperature, % |
| Example 1a | 82.2 | 1.47 | 81.1 | 3.21 | 83.1 |
| Example 2a | 84.3 | 1.38 | 84.2 | 3.19 | 85.7 |
| Example 3a | 78.2 | 1.52 | 78.3 | 3.87 | 77.3 |
| Example 4a | 72.6 | 1.66 | 71.2 | 3.92 | 73.8 |
| Example 5a | 73.7 | 1.64 | 74.4 | 3.72 | 72.1 |
| Example 6a | 69.5 | 2.04 | 68.5 | 4.98 | 69.8 |
| Example 7a | 75.1 | 1.67 | 75.9 | 3.68 | 76.4 |
| Example 8a | 82.1 | 1.48 | 83.4 | 3.22 | 83.7 |
| Example 9a | 74.3 | 1.72 | 73.5 | 3.77 | 72.3 |
| Example 10a | 70.2 | 1.88 | 71.5 | 3.24 | 72.2 |
| Example 11a | 69.9 | 1.84 | 70.9 | 3.98 | 71.7 |
| Example 12a | 83.1 | 1.43 | 81.7 | 3.31 | 82.8 |
| Example 13a | 81.2 | 1.39 | 84.7 | 3.47 | 83.6 |
| Example 14a | 83.3 | 1.41 | 83.6 | 3.39 | 81.7 |
| Example 15a | 80.9 | 1.32 | 81.3 | 3.26 | 81.5 |
| Example 16a | 76.6 | 1.62 | 73.5 | 4.01 | 77.4 |
| Example 17a | 76.1 | 1.69 | 73.0 | 4.08 | 76.8 |
| Example 18a | 75.7 | 1.71 | 72.6 | 4.11 | 76.4 |
| Example 19a | 74.9 | 1.77 | 71.4 | 4.14 | 75.3 |
| Example 20a | 72.5 | 1.99 | 68.5 | 4.30 | 72.4 |
| Example 21a | 73.8 | 1.90 | 69.7 | 4.25 | 73.5 |
| Example 22a | 73.2 | 1.92 | 69.4 | 4.28 | 73.1 |
| Example 23a | 72.8 | 1.95 | 69.0 | 4.29 | 72.7 |
| Example 24a | 74.1 | 1.88 | 70.3 | 4.22 | 74.2 |
| Example 25a | 72.0 | 2.07 | 68.1 | 4.33 | 71.8 |
| Example 26a | 74.8 | 1.80 | 71.2 | 4.15 | 75.0 |
| Example 27a | 74.3 | 1.83 | 70.7 | 4.17 | 74.6 |
| Comparative | 63.3 | 2.43 | 63.2 | 4.76 | 63.5 |
| Example 1a | | | | | |
| Comparative | 62.2 | 2.56 | 64.1 | 4.98 | 60.5 |
| Example 2a | | | | | |
| Comparative | 60.8 | 2.78 | 61.1 | 5.03 | 61.2 |
| Example 3a | | | | | |

Table 2 above reveals that the gas generation volumes of the lithium-ion batteries of Examples 1a to 27a was lower than those of the lithium-ion batteries of Comparative Examples 1a to 3a, and the cycling performance and the high-temperature performance of the lithium-ion batteries of Examples 1a to 27a were also better than those of the lithium-ion batteries of Comparative Examples 1a to 3a. This indicates that when the electrolyte additive or the electrolyte of the present disclosure is used in the battery, the free movement of the hindered oxalate-containing lithium salt is reduced, thereby reducing the contact between the oxalate group and the electrodes of the battery. As a result, the gas generation reaction of the oxalate group is less likely to occur, while the damage to the SEI film caused by battery swelling due to gas generation is mitigated, thereby improving the stability of the battery under the high-temperature and long-cycle conditions.

When comparing Examples 1a-15a with Example 16a, the gas generation volume of the lithium-ion battery of Example 16a was slightly increased, and its cycling performance and high-temperature performance were slightly reduced, indicating that the electrolyte lithium salt is beneficial for improving the high-temperature and long-cycling performance of the battery and reducing the gas generation. When comparing Example 1a with Comparative Example 1a, the high-temperature performance and the cycling performance of the lithium-ion battery of Example 1a were better than those of Comparative Example 1a. This is because the effect of the first lithium salt additive on improving the high temperature performance and the cycling performance of the battery was reduced when the electrolyte additive or the electrolyte did not contain first lithium salt additive (e.g., lithium difluoro(oxalato)borate). When comparing Example 1a with Comparative Example 2a, the gas generation volume of the lithium-ion battery of Example 1a was lower than that of the lithium-ion battery of Comparative Example 2a, and the cycling performance and the high-temperature performance of the lithium-ion battery of Example 1a were also better than those of the lithium-ion battery of Comparative Example 2a. This is because the restrictive effect between the sulfate ester compound and the first lithium salt additive was weakened when the electrolyte additive or the electrolyte did not contain sulfate ester compound. As a result, the gas generation reaction of the first lithium salt additive was intensified, affecting the high-temperature and long-cycling performance of the battery. When comparing Example 1a with Comparative Example 3a, the gas generation volume of the lithium-ion battery of Example 1a was lower than that of the lithium-ion battery of Comparative Example 3a, and the cycling performance and the high-temperature performance of the lithium-ion battery of Example 1a were also better than those of the lithium-ion battery of Comparative Example 3a, indicating that the simultaneous presence of these two components (the first lithium salt additive and the sulfate ester compound) in the electrolyte additive or the electrolyte can improve the high-temperature and room-temperature cycling performance of the battery.

The following examples are used for illustrating applications of the electrolyte additive and the electrolyte containing the same of the present disclosure in a lithium-ion battery with LiFePO₄ positive electrode.

### Example 1b

Example 1b was the same as Example 1a, except for the preparation of the positive electrode plate.

A lithium iron phosphate positive electrode active material, a conductive agent carbon black SP, a binder polyvinylidene fluoride, and a dispersant polyacrylate were mixed at a mass ratio of 97.2:0.8:1.8:0.2, followed by high-speed stirring and dispersion, to obtain a positive electrode slurry. The obtained positive electrode slurry was used to prepare the positive electrode plate. The positive electrode plate had a single-side areal density of 230 g/m² and a compacted density of 2.50 g/cm³.

The differences between Examples 2b to 11b and Comparative Examples 1b to 3b and Example 1b are shown in Table 3.

TABLE 3

| | | | | | | | Molar | Mass ratio | | |
|---|---|---|---|---|---|---|---|---|---|---|
| | | | | | | | ratio of | of | | |
| | | | | | | | first | electrolyte | Ratio of | |
| | | | | | | | lithium | lithium | total | |
| | | | | | | | salt | salt to | mass of | |
| | | | | | | | additive | first | electrolyte | |
| | Sulfate ester | | First lithium salt | | Electrolyte | | to | lithium | to | |
| | compound | | additive | | lithium salt | | sulfate | salt | battery | |
| No. | Type | Content, wt % | Type | Content wt % | Type | Content, wt % | ester compound | additive N/(g/Ah) | discharge capacity | $\frac{φ \times N \times C}{1 {0}^{4} \times t \times R}$ |
| Example | Compound | 0.3 | Lithium | 3.40 | LiBF₄ | 0.15 | 0.1 | 0.5 | 8.61 | 0.01 |
| 1b | 1 | | difluoro | | | | | | | |
| | | | (oxalato) | | | | | | | |
| | | | borate | | | | | | | |
| Example | Compound | 0.3 | Lithium | 1.39 | LiBF₄ | 0.15 | 0.5 | 0.5 | 9.13 | 0.02 |
| 2b | 1 | | difluoro | | | | | | | |
| | | | (oxalato) | | | | | | | |
| | | | borate | | | | | | | |
| Example | Compound | 3 | Lithium | 0.69 | LiBF₄ | 0.15 | 1 | 0.05 | 5.27 | 0.09 |
| 3b | 1 | | difluoro | | | | | | | |
| | | | (oxalato) | | | | | | | |
| | | | borate | | | | | | | |
| Example | Compound | 0.3 | Lithium | 1.39 | LiBF₄ | 0.15 | 0.5 | 0.5 | 10.28 | 0.02 |
| 4b | 2 | | difluoro | | | | | | | |
| | | | (oxalato) | | | | | | | |
| | | | borate | | | | | | | |
| Example | Compound | 0.3 | Lithium | 1.39 | LiBF₄ | 0.15 | 0.5 | 0.5 | 10.33 | 0.02 |
| 5b | 3 | | difluoro | | | | | | | |
| | | | (oxalato) | | | | | | | |
| | | | borate | | | | | | | |
| Example | Compound | 0.3 | Lithium | 1.39 | LiBF₄ | 0.15 | 0.5 | 0.5 | 10.31 | 0.02 |
| 6b | 4 | | difluoro | | | | | | | |
| | | | (oxalato) | | | | | | | |
| | | | borate | | | | | | | |
| Example | Compound | 0.3 | Lithium | 1.39 | LiBF₄ | 0.15 | 0.5 | 0.5 | 10.38 | 0.02 |
| 7b | 5 | | difluoro | | | | | | | |
| | | | (oxalato) | | | | | | | |
| | | | borate | | | | | | | |
| Example | Compound | 0.3 | Lithium | 1.39 | LiBF₄ | 0.15 | 0.5 | 0.5 | 9.57 | 0.02 |
| 8b | 1 | | tetrafluoro | | | | | | | |
| | | | (oxalato) | | | | | | | |
| | | | phosphate | | | | | | | |
| Example | Compound | 0.3 | Lithium | 1.39 | LiBF₄ | 0.15 | 0.5 | 0.5 | 9.18 | 0.02 |
| 9b | 1 | | difluoro | | | | | | | |
| | | | (oxalato) | | | | | | | |
| | | | borate | | | | | | | |
| Example | Compound | 0.3 | Lithium | 1.39 | LiN | 0.15 | 0.5 | 0.5 | 9.77 | 0.02 |
| 10b | 1 | | difluoro | | (SO₂F)₂ | | | | | |
| | | | (oxalato) | | | | | | | |
| | | | borate | | | | | | | |
| Example | Compound | 0.3 | Lithium | 1.39 | / | / | 0.5 | / | 12.26 | 0.02 |
| 11b | 1 | | difluoro | | | | | | | |
| | | | (oxalato) | | | | | | | |
| | | | borate | | | | | | | |
| Comparative | Compound | / | / | 1.39 | LiBF₄ | 0.15 | / | / | 16.34 | / |
| Example | 1 | | | | | | | | | |
| 1b | | | | | | | | | | |
| Comparative | / | 0.3 | Lithium | / | LiBF₄ | 0.15 | / | 0.5 | 18.25 | 0.03 |
| Example | | | difluoro | | | | | | | |
| 2b | | | (oxalato) | | | | | | | |
| | | | borate | | | | | | | |
| Comparative | 13 | / | / | / | / | LiBF₄ | 0.15 | / | 21.43 | / |
| Example | | | | | | | | | | |
| 3b | | | | | | | | | | |

The aforementioned examples and comparative examples were subjected to the aforementioned high-temperature storage performance test, high-temperature cycling performance test, and room-temperature cycling performance test. The test results are shown in Table 4.

TABLE 4

| | | Gas generation | | Gas generation | |
|---|---|---|---|---|---|
| | | volume by | | volume by | |
| | Capacity | water | | water | Capacity |
| | retention rate | displacement | Capacity | displacement | retention rate |
| | after 500 | method after | retention after | method after | after 500 |
| | cycles at | full charge at | 60-day storage | 60-day storage | cycles at room |
| No. | 45° C., % | 60° C., cm³ | at 60° C., % | at 60° C., cm³ | temperature, % |
| Example 1b | 83.2 | 1.46 | 83.5 | 3.41 | 84.8 |
| Example 2b | 84.6 | 1.33 | 84.9 | 3.23 | 85.4 |
| Example 3b | 77.5 | 1.76 | 75.2 | 3.74 | 77.6 |
| Example 4b | 83.4 | 1.39 | 82.6 | 3.26 | 82.5 |
| Example 5b | 83.2 | 1.36 | 82.7 | 3.31 | 84.5 |
| Example 6b | 83.6 | 1.45 | 83.1 | 3.37 | 84.1 |
| Example 7b | 82.1 | 1.42 | 82.7 | 3.42 | 83.3 |
| Example 8b | 73.4 | 1.57 | 74.4 | 3.87 | 74.3 |
| Example 9b | 74.1 | 1.53 | 74.9 | 3.83 | 74.8 |
| Example 10b | 72.9 | 1.62 | 73.8 | 3.88 | 73.6 |
| Example 11b | 72.5 | 1.66 | 73.2 | 3.91 | 73.1 |
| Comparative | 60.2 | 2.43 | 63.3 | 4.31 | 62.6 |
| Example 1b | | | | | |
| Comparative | 63.1 | 2.02 | 62.8 | 4.59 | 64.4 |
| Example 2b | | | | | |
| Comparative | 62.2 | 2.66 | 61.9 | 5.07 | 63.1 |
| Example 3b | | | | | |

Table 4 above reveals that the gas generation volumes of the lithium-ion batteries of Examples 1b to 11b were lower than those of the lithium-ion batteries of Comparative Examples 1b to 3b, and the cycling performance and the high-temperature performance of each of the lithium-ion batteries of Examples 1b to 11b were also better than those of the lithium-ion batteries of Comparative Examples 1b to 3b. This indicates that the electrolyte additive or the electrolyte of the present disclosure, when used in the battery, can improve the stability of the battery under the high-temperature and long-cycle conditions and reduce the gas generation.

When compared Examples 1b to 7b with Example 8b, the gas generation volume of the lithium-ion battery of Example 8b was slightly increased, and the cycling performance and the high-temperature performance of the lithium-ion battery of Example 8b were slightly reduced, indicating that the electrolyte lithium salt was beneficial to improving the high-temperature and long-cycling performance of the battery and reducing the gas generation.

When comparing Example 1b with Comparative Example 1b, the high-temperature performance and the cycling performance of the lithium-ion battery of Example 1b were better than those of Comparative Example 1b. This is because the effect of the first lithium salt additive in improving the high-temperature performance and the cycle-performance of the battery is reduced when the electrolyte additive or the electrolyte does not contain first lithium salt additive (e.g., lithium difluoro(oxalato)borate).

When comparing Example 1b with Comparative Example 2b, the gas generation of the lithium-ion battery of Example 1b was lower than that of the lithium ion battery of Comparative Example 2b, and the cycling performance and the high-temperature performance of the lithium-ion battery of Example 1b were also better than those of the lithium-ion battery of Comparative Example 2b. This is because the restrictive effect between the sulfate ester compound and the first lithium salt additive was weakened when the electrolyte additive or the electrolyte did not contain sulfate ester compound. As a result, the gas generation reaction of the first lithium salt additive was intensified, affecting the high-temperature and long-cycling performance of the battery.

When comparing Example 1b with Comparative Example 3b, the gas generation volume of the lithium-ion battery of Example 1b was lower than that of the lithium-ion battery of Comparative Example 3b, and the cycling performance and the high-temperature performance of the lithium-ion battery of Example 1b were also better than those of the lithium-ion battery of Comparative Example 3b, indicating that the simultaneous presence of these two components (the first lithium salt additive and the sulfate ester compound) in the electrolyte additive or the electrolyte can improve the high-temperature and room-temperature cycling performance of the battery.

The following examples are used for illustrating applications of the electrolyte additive and the electrolyte containing the same of the present disclosure in a lithium-ion battery with silicon-oxygen negative electrode.

### Example 1c

Example 1c was the same as Example 1a, except for the preparation of the negative electrode plate.

SI420/Zichen SIO-1300L-240116 as a negative electrode active material, a conductive agent SP, a binder SBR (JSR-104A), a thickener CMC (crt30000PA) and a conductive material CNT were mixed at a weight ratio of 94.94:1.5:2:1.5:0.06, and water was added to form a slurry, with a solid content controlled at 49.05%. The mixture was stirred in a vacuum mixer to obtain a negative electrode slurry. The negative electrode slurry was uniformly coated onto a copper foil having a thickness of 9 μm. The copper foil coated with the negative electrode slurry was dried at 80° C. for 5 hours. Finally, calendering is carried out to control the compacted density of the negative electrode plate at 1.4 g/cm³, followed by slitting, to obtain the negative electrode plate. The porosity φ of the negative electrode plate was 70%.

The differences between Examples 2c to 7c and Comparative Examples 1c to 3c and Example 1c are shown in Table 5.

TABLE 5

| | | | | | | | Molar | Mass | Ratio of | |
|---|---|---|---|---|---|---|---|---|---|---|
| | | | | | | | ratio of | ratio of | total mass | |
| | | | | | | | first | electrolyte | of | |
| | | | | | | | lithium | lithium | electrolyte | |
| | | | | | | | salt | salt to | to | |
| | Sulfate ester | | First lithium salt | | Electrolyte | | additive | first | discharge | |
| | compound | | additive | | lithium salt | | to sulfate | lithium | capacity of | |
| No. | Type | Content, wt % | Type | Content, wt % | Type | Content, wt % | ester compound | salt additive | battery N/(g/Ah) | $\frac{φ \times N \times C}{1 {0}^{4} \times t \times R}$ |
| Example | Compound | 3.40 | Lithium | 0.3 | LiBF₄ | 0.15 | 0.1 | 0.5 | 4.62 | 0.08 |
| 1c | 1 | | difluoro | | | | | | | |
| | | | (oxalato) | | | | | | | |
| | | | borate | | | | | | | |
| Example | Compound | 1.39 | Lithium | 0.3 | LiBF₄ | 0.15 | 0.5 | 0.5 | 4.71 | 0.04 |
| 2c | 1 | | difluoro | | | | | | | |
| | | | (oxalato) | | | | | | | |
| | | | borate | | | | | | | |
| Example | Compound | 0.69 | Lithium | 3 | LiBF₄ | 0.15 | 1 | 0.05 | 7.04 | 0.03 |
| 3c | 1 | | difluoro | | | | | | | |
| | | | (oxalato) | | | | | | | |
| | | | borate | | | | | | | |
| Example | Compound | 23.23 | Lithium | 5 | LiBF₄ | 0.15 | 0.5 | 0.03 | 3.45 | 0.44 |
| 4c | 1 | | difluoro | | | | | | | |
| | | | (oxalato) | | | | | | | |
| | | | borate | | | | | | | |
| Example | Compound | 1.39 | Lithium | 0.3 | LiBF₄ | 0.15 | 0.5 | 0.5 | 5.12 | 0.04 |
| 5c | 1 | | tetrafluoro | | | | | | | |
| | | | (oxalato) | | | | | | | |
| | | | phosphate | | | | | | | |
| Example | Compound | 1.39 | Lithium | 0.3 | LiPF₆ | 0.15 | 0.5 | 0.5 | 5.14 | 0.04 |
| 6c | 1 | | difluoro | | | | | | | |
| | | | (oxalato) | | | | | | | |
| | | | borate | | | | | | | |
| Example | Compound | 1.39 | Lithium | 0.3 | LiN | 0.15 | 0.5 | 0.5 | 5.21 | 0.04 |
| 7c | 1 | | difluoro | | (SO₂F)₂ | | | | | |
| | | | (oxalato) | | | | | | | |
| | | | borate | | | | | | | |
| Comparative | Compound | 1.39 | / | / | LiBF₄ | 0.15 | / | / | 15.34 | 0.11 |
| Example | 1 | | | | | | | | | |
| 1c | | | | | | | | | | |
| Comparative | / | / | Lithium | 0.3 | LiBF₄ | 0.15 | / | 0.5 | 20.23 | / |
| Example | | | difluoro | | | | | | | |
| 2c | | | (oxalato) | | | | | | | |
| | | | borate | | | | | | | |
| Comparative | / | / | / | / | LiBF₄ | 0.15 | / | / | 24.57 | / |
| Example | | | | | | | | | | |
| 3c | | | | | | | | | | |

The aforementioned examples and comparative examples were subjected to the aforementioned high-temperature storage performance test, high-temperature cycling performance test, and room-temperature cycling performance test. The test results are shown in Table 6.

TABLE 6

| | | Gas generation | | Gas generation | |
|---|---|---|---|---|---|
| | | volume by | | volume by | |
| | Capacity | water | | water | Capacity |
| | retention rate | displacement | Capacity | displacement | retention rate |
| | after 500 | method after | retention after | method after | after 500 |
| | cycles at | full charge at | 60-day storage | 60-day storage | cycles at room |
| No. | 45° C., % | 60° C., cm³ | at 60° C., % | at 60° C., cm³ | temperature, % |
| Example 1c | 85.8 | 1.35 | 81.5 | 3.14 | 86.6 |
| Example 2c | 86.7 | 1.29 | 83.2 | 2.98 | 87.9 |
| Example 3c | 81.3 | 1.48 | 77.6 | 3.45 | 82.4 |
| Example 4c | 76.1 | 1.69 | 72.1 | 3.77 | 77.2 |
| Example 5c | 78.3 | 1.65 | 75.1 | 3.92 | 79.6 |
| Example 6c | 77.9 | 1.71 | 74.6 | 4.03 | 78.9 |
| Example 7c | 77.4 | 1.77 | 74.2 | 4.08 | 78.2 |
| Comparative | 65.3 | 2.25 | 65.7 | 4.71 | 66.1 |
| Example 1c | | | | | |
| Comparative | 64.6 | 2.46 | 65.9 | 4.87 | 65.8 |
| Example 2c | | | | | |
| Comparative | 62.1 | 2.87 | 62.4 | 5.02 | 62.9 |
| Example 3c | | | | | |

Table 6 above reveals that the gas generation volumes of the lithium-ion batteries of Examples 1c to 7c were lower than those of the lithium-ion batteries of Comparative Examples 1c to 3c, and the cycling performance and the high-temperature performance of each of the lithium-ion batteries of Examples 1c to 7c were also better than those of the lithium-ion batteries of Comparative Examples 1c to 3c. This indicates that the electrolyte additive or the electrolyte of the present disclosure, when used in the battery, can improve the stability of the battery under the high-temperature and long-cycle conditions and reduce the gas generation.

When comparing Example 1c with Comparative Example 1c, the high-temperature performance and the cycling performance of the lithium-ion battery of Example 1c were better than those of Comparative Example 1c. This is because the effect of the first lithium salt additive in improving the high-temperature performance and the cycle-performance of the battery is reduced when the electrolyte additive or the electrolyte does not contain first lithium salt additive (e.g., lithium difluoro(oxalato)borate).

When comparing Example 1c with Comparative Example 2c, the gas generation of the lithium-ion battery of Example 1c was lower than that of the lithium ion battery of Comparative Example 2c, and the cycling performance and the high-temperature performance of the lithium-ion battery of Example 1c were also better than those of the lithium-ion battery of Comparative Example 2c. This is because the restrictive effect between the sulfate ester compound and the first lithium salt additive was weakened when the electrolyte additive or the electrolyte did not contain sulfate ester compound. As a result, the gas generation reaction of the first lithium salt additive was intensified, affecting the high-temperature and long-cycling performance of the battery.

When comparing Example 1c with Comparative Example 3c, the gas generation volume of the lithium-ion battery of Example 1c was lower than that of the lithium-ion battery of Comparative Example 3c, and the cycling performance and the high-temperature performance of the lithium-ion battery of Example 1c were also better than those of the lithium-ion battery of Comparative Example 3c, indicating that the simultaneous presence of these two components (the first lithium salt additive and the sulfate ester compound) in the electrolyte additive or the electrolyte can improve the high-temperature and room-temperature cycling performance of the battery.

Unless otherwise specified, all the scientific and technical terms used in the present disclosure have the same meaning as those commonly understood by those skilled in the art to which the present disclosure belongs. All the patents and publications referred to in the present disclosure are incorporated by reference in their entirety. The terms such as “comprising” or “including” as used herein are open-ended expressions, i.e., including contents specified in the present disclosure but not excluding other contents.

In the description of this specification, descriptions with reference to the terms such as “an embodiment” and “another embodiment” means that a particular feature, structure, material, or characteristic described in connection with the embodiment is included in at least one embodiment of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features of different embodiments or examples described in the specification may be combined by those skilled in the art without mutual contradiction. In addition, it should be noted that, in this specification, the terms such as “first” and “second” are used herein for purposes of description and are not intended to indicate or imply relative importance, or to implicitly show the number of indicated technical features.

Although embodiments of the present disclosure have been shown and described, it would be appreciated by those skilled in the art that the above embodiments cannot be construed to limiting the present disclosure, and changes, modifications, alternatives, and alterations can be made in the embodiments without departing from scope of the present disclosure.

What is claimed is:

1. A battery, comprising: a positive electrode plate, a negative electrode plate, a separator, and an electrolyte, wherein:
the negative electrode plate has a porosity of φ in unit of %;
the separator has a thickness of t in unit of μm, and a pore size of R in unit of μm;
a ratio of a total mass of the electrolyte to a discharge capacity of the battery is N in unit of g/Ah; and
the electrolyte comprises an electrolyte additive, the electrolyte additive comprising a sulfate ester compound and a first lithium salt additive, wherein the first lithium salt additive comprises an oxalate-containing lithium salt, and the sulfate ester compound has a structure represented by Formula I: 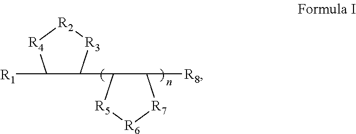
wherein:
R₁ and R₈ are each independently selected from hydrogen or C₁ to C₅ hydrocarbyl;
R₂, R₃, R₄, R₅, R₆, and R₇ are each independently selected from C₁ to C₃ alkylene, C₁ to C₃ alkoxy, an oxygen atom, 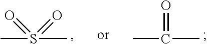
and
n is an integer ranging from 0 to 4, and
a mass fraction of the sulfate ester compound in the electrolyte is C in unit of %; and
the battery satisfies Formula A:
$$0.01 \leq \frac{φ \times N \times C}{1 {0}^{4} \times t \times R} \leq 0.5 . \qquad Formula A$$

2. The battery according to claim 1, wherein:
φ ranges from 60% to 80%; and/or
t ranges from 12 μm to 20 μm; and/or
R ranges from 0.03 μm to 0.12 μm; and/or
C ranges from 0.1% to 10%; and/or
N ranges from 2.0 to 5.0.

3. The battery according to claim 1, wherein:
R₁ and R₈ are each independently selected from hydrogen;
at least one of R₂, R₃, or R₄ is selected from 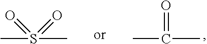
and at least one of R₂, R₃, or R₄ is selected from an oxygen atom;
at least one of R₅, R₆, or R₇ is selected from 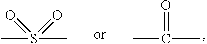
and at least one of R₅, R₆, or R₇ is selected from an oxygen atom; and
n is 2.

4. The battery according to claim 1, wherein the sulfate ester compound has any one of the following structures:

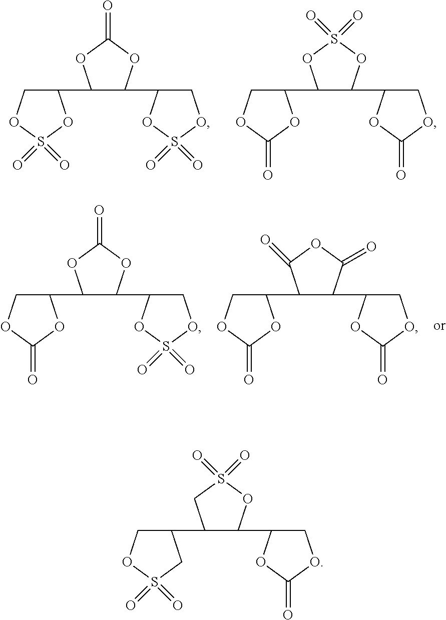

5. The battery according to claim 1, wherein the first lithium salt additive comprises at least one of lithium difluoro(oxalato)borate, lithium bis(oxalato)borate, lithium tetrafluoro (oxalato)phosphate, lithium difluorobis(oxalato)phosphate, or lithium tris(oxalato)phosphate.

6. The battery according to claim 1, wherein a molar ratio of the first lithium salt additive to the sulfate ester compound is 1:(1 to 5).

7. The battery according to claim 1, wherein:
a mass fraction of the first lithium salt additive in the electrolyte ranges from 0.1% to 5%; and/or
a mass fraction of the sulfate ester compound in the electrolyte ranges from 1% to 10%.

8. The battery according to claim 1, wherein the electrolyte additive further comprises an electrolyte lithium salt, wherein the electrolyte lithium salt comprises at least one of LiBF₄, LiPF₆, LiAsF₆, or LiN(SO₂F)₂.

9. The battery according to claim 8, wherein a mass ratio of the electrolyte lithium salt to the first lithium salt additive is 1:(0.4 to 2).

10. The battery according to claim 8, wherein a mass fraction of the electrolyte lithium salt in the electrolyte ranges from 0.1% to 1%.

11. The battery according to claim 1, wherein the positive electrode plate comprises:
a positive electrode current collector; and
a positive electrode active material layer located on at least one side of the positive electrode current collector,
wherein the positive electrode active material layer comprises a positive electrode active material, wherein the positive electrode active material comprises at least one of lithium iron phosphate, or a ternary material, wherein the ternary material satisfies a chemical formula of LiNiₓCo_{y}M1_{z1}M2_{z2}O₂, wherein:
M1 and M2 are different and each independently selected from one of Al, Mn, or Fe; and
0<x≤1, 0<y<1, 0<z1<1, 0≤z2<1, and x+y+z1+z2=1.
